(19) United States
(12) Patent Application Publication
(10) Pub. No.: US 2016/0341872 A1
(43) Pub. Date: Nov. 24, 2016

(54) LIGHT GUIDE PLATE, BACK LIGHT MODULE AND LIQUID CRYSTAL DISPLAY DEVICE

(71) Applicant: WUHAN CHINA STAR OPTOELECTRONICS TECHNOLOGY CO., LTD., Wuhan, Hubei (CN)

(72) Inventor: Yanxue ZHANG, Wuhan, Hubei (CN)

(21) Appl. No.: 14/768,368

(22) PCT Filed: May 22, 2015
(86) PCT No.: PCT/CN2015/079620

§ 371 Date: Aug. 17, 2015

(30) Foreign Application Priority Data
May 19, 2015 (CN) 201510255882.0

(51) Int. Cl. F21V 8/00

(52) U.S. Cl. CPC G02B 6/0021; G02B 6/0068; G02B 6/005

(57) ABSTRACT

A light guide plate including a plate body and a light coupling device connected to one end of the plate body; the light coupling device includes a light incident surface, a connection surface parallelly opposing the light incident surface, and a top surface and a bottom surface connected to the light incident surface and the connection surface respectively. Wherein, the connection surface is connected with the plate body, a width of the light incident surface is larger than a width of the connection surface, the top surface is a wedge-shaped inclined surface protruding upwardly, and the bottom surface is a wedge-shaped inclined surface protruding downwardly. The light incident surface is provided with at least one assembling groove. A back light module having the light guide plate and a liquid crystal display device including the back light module is disclosed.

### TECHNICAL FIELD

The present invention relates to the technical field of liquid crystal display, and more particularly, to a light guide plate, a back light module including the light guide plate and a liquid crystal display device.

### BACKGROUND ART

With the evolution of photoelectric and semiconductor technology, the flat panel display is also developing fast. Among the various types of flat panel displays, the liquid crystal display (LCD) has become the mainstream of market due to the superior characteristics, such as higher space utilization, lower power consumption, zero radiation, and lower electro-magnetic interference, and so on. The liquid crystal display normally includes a liquid crystal panel and a back light module. The liquid crystal display panel itself is not self-luminous, hence the back light module must be disposed below the liquid crystal display panel so as to supply the liquid crystal display panel with the required area light source, by this way the liquid crystal display panel may display the image via the area light source supplied by the back light module.

With the development of the consumer electronics, the high resolution design has become one of the important factors for improving the competitiveness of the product. The increase of resolution will significantly lower the transmittance of the product, thus a backlight source with even higher brightness is required. In backlight design, the improved light coupling efficiency of the light source and the light guide plate may play an important role in promoting the brightness of the product.

### SUMMARY

For this purpose, the present invention provides a light guide plate and a back light module, which can improve the light coupling efficiency of the light source and the light guide plate.

In order to achieve the above purpose, the present invention adopts the following technical solutions:

a light guide plate, wherein the light guide plate includes a plate body and a light coupling device connected to one end of the plate body; the light coupling device includes a light incident surface, a connection surface parallelly opposing the light incident surface, and a top surface and a bottom surface connected to the light incident surface and the connection surface respectively; wherein the connection surface is connected with the plate body, a width of the light incident surface is larger than a width of the connection surface, the top surface is a wedge-shaped inclined surface protruding upwardly, and the bottom surface is a wedge-shaped inclined surface protruding downwardly; wherein the light incident surface is provided with at least one assembling groove.

Wherein the top surface and the bottom surface are in a longitudinal symmetry structure, and the plate body and the light coupling device are molded integrally molded.

Wherein the bottom surface further extends in a direction away from the plate body to form an extension portion in a plate shape.

Wherein the light incident surface is provided with a plurality of assembling grooves spaced from one another.

Another aspect of the present invention provides a back light module including a light guide plate and a light source, wherein the light guide plate includes a plate body and a light coupling device connected to one end of the plate body; the light coupling device includes a light incident surface, a connection surface parallelly opposing the light incident surface, and a top surface and a bottom surface connected to incident surface and the connection surface respectively; wherein the connection surface is connected with the plate body, a width of the light incident surface is larger than a width of the connection surface, the top surface is a wedge-shaped inclined surface protruding upwardly, and the bottom surface is a wedge-shaped inclined surface protruding downwardly; wherein the light incident surface is provided with at least one assembling groove; the light source is provided in the assembling groove.

Wherein the bottom surface further extends in a direction away from the plate body to form an extension portion in a plate shape, and the light source is loaded on the extension portion.

Wherein the light source is a light string including a plurality of LED lights, the light incident surface is provided with a plurality of assembling grooves spaced from one another, and each of the LED lights is placed accordingly in one of the assembling grooves.

Wherein the back light module further includes a back plate, a reflecting plate and an optical film set; the light guide plate and the light source are provided in the back plate; the reflecting plate is provided between the back plate and the light guide plate and is located below the plate body; the optical film set is provided on the light guide plate and is located above the plate body.

The present invention also provides a liquid crystal display device, including a liquid crystal panel and a back light module; the liquid crystal panel is provided to face the back light module, and the back light module provides a display light source to the liquid crystal panel, so that the liquid crystal panel may display an image, wherein the back light module is the aforementioned back light module.

### Advantageous Effects

The light guide plate and back light module according to the embodiment of the present invention, wherein a light coupling device with double inclined surfaces and a wedge shape is provided, an assembling groove is provided light coupling device, and a light source is provided in the assembling groove, hence reducing the light leakage of the front and bottom surfaces of the light source, thereby increasing the light coupling efficiency of the light source and the light guide plate.

### BRIEF DESCRIPTION OF THE DRAWINGS

FIG. 1 is a perspective view of a light guide plate according to an embodiment of the present invention.

FIG. 2 is a structure cross-section view of a back light module according to an embodiment of the present invention.

FIG. 3 is a structure diagram of a liquid crystal display according to an embodiment of the present invention.

### DETAILED DESCRIPTION OF EXEMPLARY EMBODIMENTS

Here the technical solutions in the embodiments of the present invention will be described in detail in conjunction with the drawings and the detailed embodiment. Obviously, the described embodiments only refer to a part of the instances of the present invention, rather than all the embodiments provided herewith. Based on the embodiments of the present invention, the other embodiments acquired by those skilled in the art without exerting any creative efforts may all fall into the protection scope of the present invention.

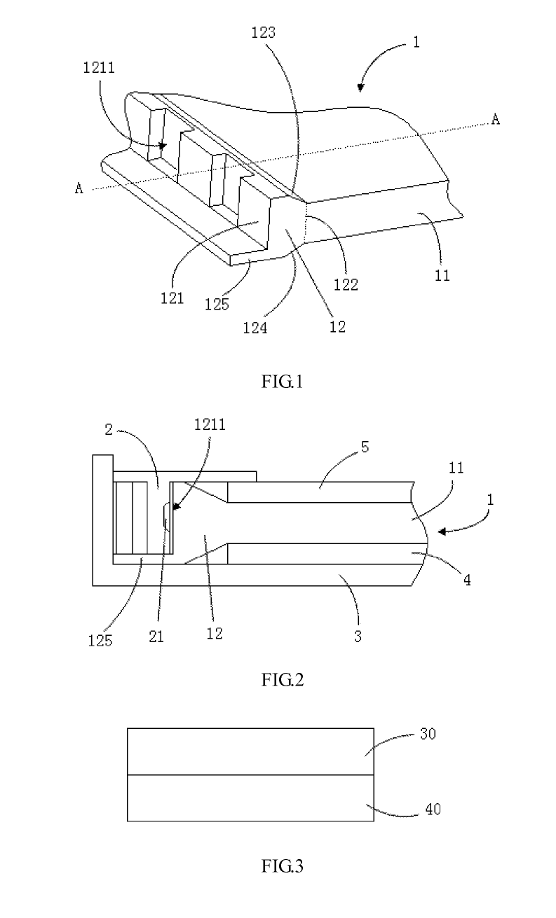

The present embodiment first provides a light guide plate. Referring to FIG. 1, the light guide plate 1 includes a plate body 11 and a light coupling device 12 connected to one end of the plate body 11. Wherein the plate body 11 has a plate shaped structure, and the light coupling device 12 is a wedge-shaped body having two inclined surfaces.

Specifically speaking, the light coupling device 12 includes a light incident surface 121, a connection surface 122 parallelly opposing the light incident surface 121, and a top surface 123 and a bottom surface 124 connected to the light incident surface 121 and the connection surface 122 respectively. Wherein the connection surface 122 is connected with the plate body 11, a width of the light incident surface 121 is larger than a width of the connection surface 122, the top surface 123 is a wedge-shaped inclined surface protruding upwardly, and the bottom surface 124 is a wedge-shaped inclined surface protruding downwardly. In the present embodiment, the top surface 123 and the bottom surface 124 are in a longitudinal symmetry structure, and the plate body 11 and the light coupling device 12 are integrally molded.

Furthermore, the light incident surface 121 is provided with at least one assembling groove 1211 (a plurality of assembling grooves 1211 spaced from one another are provided on the light incident surface 121 in this embodiment). Meanwhile, the bottom surface 124 extends in a direction away from the plate body 11 to form an extension portion 125 in a plate shape.

The present embodiment further provides a back light module including the aforementioned light guide plate. FIG. 2 is a structure cross-section view of a back light module according to the present embodiment, wherein the light guide plate 1 illustrated in FIG. 2 is the cross-section view taken along the A-A line shown in FIG. 1. As shown in FIG. 2, the back light module includes a light guide plate 1, a light source 2, a back plate 3, a reflecting plate 4 and an optical film set 5. Specifically speaking, the reflecting plate 4, the light guide plate 1 and the optical film set 5 are sequentially laminated on the back plate 3, also, the reflecting plate 4 is provided below the plate body 11 of the light guide plate 1, and the optical film set 5 is provided above the plate body 11 of the light guide plate 1.

Wherein the light source 2 is assembled on the extension portion 125 and is assembled in the assembling groove 1211. In the present embodiment, the light source 2 is a light string including a plurality of LED lights 21, and each of the LED lights 21 is placed accordingly in one of the assembling grooves 1211. The light emitted from the light source 2 is incident on the plate body 11 through being coupled by the light coupling device 12, and is reflected by the reflecting plate 4, and then emerges from the optical film set 5 above the plate body 11.

In the aforementioned back light module, the light coupling device with double inclined surfaces and a wedge shape is provided, the assembling groove is provided light coupling device, and the light source is provided in the assembling groove, hence reducing the light leakage of the front and bottom surfaces of the light source. In addition, the light coupling device is coupled with the extension portion in a plate shape, and the light source is assembled on the extension portion, hence further reducing the light leakage of the bottom of the light source, thereby increasing the light coupling efficiency of the light source and the light guide plate.

Another aspect of the present embodiment provides a liquid crystal display device. Referring to FIG. 3, the liquid crystal display device includes a liquid crystal panel 30 and a back light module 40; the liquid crystal panel 30 is provided to face the back light module 40, and the back light module 40 provides a display light source to the liquid crystal panel 30, so that the liquid crystal panel 30 may display an image, wherein the back light module 40 is the module provided in the present embodiment.

It should be explained that the relationship terms, such as first and second, etc., in the present specification are only used for distinguishing one entity or operation from another entity or operation without requiring or implying any actual relation or sequence existing between these entities or operations. Moreover, the term “include”, “contain” or any other variant means covering instead of exclusively including, so that the process, method, object or device including a series of factors not only includes those factors but also includes other factors that are not explicitly listed or further include inherent factors for this process, method, object or device. Where no more limitations are provided, the factors defined by the sentence “include one . . . ” do not exclude additional identical factors existing in the process, method, object or device which includes the factors.

Obviously, the protection scope of the present invention is not limited to the above detailed descriptions, and those skilled in the art may make various changes and modifications to the invention without departing from the scope and spirit of the invention. As such, if these changes and modifications of the present invention belong to the scope of the claims of the present invention and equivalent technologies thereof, the present invention also intends to include these changes and modifications here.

What is claimed is:

1. A light guide plate, including a plate body and a light coupling device connected to one end of the plate body, the light coupling device includes a light incident surface, a connection surface parallelly opposing the light incident surface, and a top surface and a bottom surface connected to the light incident surface and the connection surface respectively; wherein the connection surface is connected with the plate body, a width of the light incident surface is larger than a width of the connection surface, the top surface is a wedge-shaped inclined surface protruding upwardly, and the bottom surface is a wedge-shaped inclined surface protruding downwardly; wherein the light incident surface is provided with at least one assembling groove.

2. The light guide plate as claimed in claim 1, wherein the top surface and the bottom surface are in a longitudinal symmetry structure, and the plate body and the light coupling device are integrally molded.

3. The light guide plate as claimed in claim 1, wherein the bottom surface further extends in a direction away from the plate body to form an extension portion in a plate shape.

4. The light guide plate as claimed in claim 3, wherein the light incident surface is provided with a plurality of assembling grooves spaced from one another.

5. A back light module, including a light guide plate and a light source, wherein
the light guide plate includes a plate body and a light coupling device connected to one end of the plate body; the light coupling device includes a light incident surface, a connection surface parallelly opposing the light incident surface, and a top surface and a bottom surface connected to the light incident surface and the connection surface respectively; wherein the connection surface is connected with the plate body, a width of the light incident surface is larger than a width of the connection surface, the top surface is a wedge-shaped inclined surface protruding upwardly, and the bottom surface is a wedge-shaped inclined surface protruding downwardly; wherein the light incident surface is provided with at least one assembling groove;
the light source is assembled in the assembling groove.

6. The back light module as claimed in claim 5, wherein the top surface and the bottom surface are in a longitudinal symmetry structure, and the plate body and the light coupling device are integrally molded.

7. The back light module as claimed in claim 5, wherein the bottom surface further extends in a direction away from the plate body to form an extension portion in a plate shape, and the light source is loaded on the extension portion.

8. The back light module as claimed in claim 7, wherein the light source is a light string including a plurality of LED lights, the light incident surface is provided with a plurality of assembling grooves spaced from one another, and each of the LED lights is placed accordingly in one of the assembling grooves.

9. The back light module as claimed in claim 5, wherein the back light module further includes a back plate, a reflecting plate and an optical film set; the light guide plate and the light source are provided in the back plate; the reflecting plate is provided between the back plate and the light guide plate and is located below the plate body; the optical film set is provided on the light guide plate and is located above the plate body.

10. A liquid crystal display device, including a liquid crystal panel and a back light module; the liquid crystal panel is provided to face the back light module, and the back light module provides a display light source to the liquid crystal panel, so that the liquid crystal panel displays an image, wherein the back light module includes the light guide plate and the light source; the light guide plate includes a plate body and a light coupling device connected to one end of the plate body; the light coupling device includes a light incident surface, a connection surface parallelly opposing the light incident surface, and a top surface and a bottom surface connected to the light incident surface and the connection surface respectively; wherein the connection surface is connected with the plate body, a width of the light incident surface is larger than a width of the connection surface, the top surface is a wedge-shaped inclined surface protruding upwardly, and the bottom surface is a wedge-shaped inclined surface protruding downwardly; wherein the light incident surface is provided with at least one assembling groove; the light source is assembled in the assembling groove.

11. The liquid crystal display device as claimed in claim 10, wherein the top surface and the bottom surface are in a longitudinal symmetry structure, and the plate body and the light coupling device are integrally molded.

12. The liquid crystal display device as claimed in claim 10, wherein the bottom surface further extends in a direction away from the plate body to form an extension portion in a plate shape, and the light source is loaded on the extension portion.

13. The liquid crystal display device as claimed in claim 12, wherein the light source is a light string including a plurality of LED lights, the light incident surface is provided with a plurality of assembling grooves spaced from one another, and each of the LED lights is placed accordingly in one of the assembling grooves.

14. The liquid crystal display device as claimed in claim 10, wherein the back light module further includes a back plate, a reflecting plate and an optical film set; the light guide plate and the light source are provided in the back plate; the reflecting plate is provided between the back plate and the light guide plate and is located below the plate body; the optical film set is provided on the light guide plate and is located above the plate body.
